(19) United States
(12) Patent Application Publication
(10) Pub. No.: US 2007/0034611 A1
(43) Pub. Date: Feb. 15, 2007

(54) System and method for self-adaptive on-line control of a flash-butt-welding machine

(76) Inventors: Francesco Drius, Cervignano (IT); Fabio Guastini, Dolegna Del Collio (IT); Daniele Venier, S. Daniele Del Fruili (IT); Giuseppe Buzzi, Pradamano (IT)

Correspondence Address: SAMPSON & ASSOCIATES, P.C., 50 CONGRESS STREET, BOSTON, MA, 02109, US

(21) Appl. No.: 10/550,636

(22) PCT Filed: Mar. 24, 2004
(86) PCT No.: PCT/IB04/01022

§ 371 Date: Oct. 30, 2006

(30) Foreign Application Priority Data
Mar. 25, 2003 (IT) MI2003A000589

(51) Int. Cl. B23K 11/04

(52) U.S. Cl. 219/110; 219/101

(57) ABSTRACT

A butt-welding control system for bars, blooms, or billets controls the welding operation by acting on an actuator (U) for opening the valve for controlling positioning of the clamps of the welding machine and on the partializer, on the basis of the operation of an observer (A) of dynamic state that observes state variables (X) of the welding process; a dynamic path generator (B) for performance variables (Z), which defines pre-determined optimal paths (Zₛₑₜ) for the performance variables (Z) to follow; a dynamic control law (C), based upon values of performance variables (Z) and of the optimal paths ₍Zₛₑₜ₎, designed to control the valve for positioning the clams (U) and the partializer on the basis of the value of the performance variables (Z) and of the desired paths; and a generator (E) of sync signals designed to generate sync signals (Sync) for the observer (A), the dynamic path generator (B) and the dynamic control law (C).

### FIELD OF THE INVENTION

The present invention relates to a method for on-line control of a butt-welding machine for bars, blooms or billets, for example of the flash-welding type, inserted in a continuous process for the manufacture of blooms or billets. The invention also relates to a control system specially devised for carrying out said method.

### STATE OF THE ART

Known to the state of the art are butt-welding processes of the flash-welding type which comprise different steps.

The first step is that of pre-heating, which starts when the welding machine receives the external enabling command to start the welding operation. In this step, the billet is gripped between the clamps, and the joints are moved closer together and moved away from one another cyclically by causing a current of strong intensity to flow therein.

Pre-heating of the billets is carried out with pulses of short duration to prevent sticking of the ends of the billets with a force greater than the force of detachment that can be supplied by the clamps. If the pre-heating voltage is too high it may occur that arcs are started. During pre-heating, the control of current generally keeps the maximum current that the power supply is able to sustain in short-circuit. The purpose of the pre-heating is not so much that of heating the billets as that of burning and then smoothing out possible irregularities of the contact surfaces in which the current were to be concentrated. In fact, in view of the low resistance of the billets, with a current of 30 000 A, it is not possible to supply a thermal power greater than some thousands of watts (3-5 kW), which produces just a modest heating lower than one degree centigrade per second.

Once the pre-heating step has terminated, normally after a pre-set time, the second step referred to as scintillation is performed. At the start of this second step, the electrical and mechanical paths of the process are aimed at causing the electric arc to start and diffuse between the joints in a regular way. Then, during fusion, the geometry of the electric arc and the thermal power, supplied to the joints, are kept on pre-set paths that optimize the result of the welding operation.

The maximum power that can be supplied in scintillation is set by acting on the supply voltage, which can be adjusted by acting on the transformation ratio of the transformer (defined as “tap changing”) and on the angle of triggering of the phase partializer present on the primary winding. There is provided a position control, which adjusts the relative distance between the clamps by means of a hydraulic cylinder. Normally, said distance is adjusted, seeking to maintain the arc current constant. Typically, the position path set for the clamps is of a parabolic type, in so far as the scintillation step is split into three time intervals which must be managed with different speeds of mutual approach of the clamps.

In the first time interval, the surface of the billets is brought to 1500° C. In this step the speeds of the clamps could even be zero in so far as the metal is not yet melting.

In the second time interval, by maintaining the power employed constant, the steel melts. Initially, the steel is cold until it comes into the vicinity of the surface of the billet, and then the heat is diffused to a large extent towards the inside of the billet, and consequently the steel melts slowly. As the billet is heated, the temperature profile in the steel tends to a constant limit shape, and the rate of fusion becomes constant. In this time interval, the speed of the clamps must be such as to follow the advance of the surfaces that are consumed.

If the welding system is supplied with a constant-voltage and low-impedance generator, this tracking of the advance of the surfaces that are consumed is not a critical factor, in so far as, if the speed of the clamps is increased, the distance is reduced, and consequently the current and the thermal power increase, and thus the speed of fusion adapts automatically to that of the clamps. The higher the speed of the clamps, the higher the current and the welding power, and the smaller the arc voltage and the welding time. However, if the speed of the clamps increases excessively, the increase in power is no longer able to compensate for the speed of approach of the billets, and a short-circuit is produced so that the undesirable phenomenon of unstable welding is brought about.

In the course of welding, the steel that melts burns the oxygen in the vicinity of the welding zone, and this entails the advantage that the welding occurs in an almost inert atmosphere. If, however, the electric arc is extinguished, oxygen enters, which generates oxide that damages the weld. In this case a further disadvantage is that, with the electric arc extinguished, the cooling of the surface of the joints is so rapid as to cause problems of re-solidification. Also brief intervals of extinction of the arc, in the region of 100 ms, if they occur shortly before the subsequent upsetting step, can jeopardize the weld.

On the other hand, during the scintillation step, the molten steel exits from the gap and brings along with it possible oxides. Consequently, possible short interruptions of arc, at a distance far from the upsetting, do not always jeopardize the outcome of the welding operation; however, arc interruptions are in any case to be prevented because, in this case, the weld receives less energy and there is a dispersion of the results of the welding operation. This case can occur if there are employed angles of triggering of the partializer that are too large, so that current drops that are generated can render the electric arc unstable and cause frequent extinctions thereof that jeopardize the weld quality.

Finally, the scintillation step also envisages a third time interval in which the gap between the ends of the billets is closed for starting the upsetting step. It is important to close the gap very fast in such a way that, in the lapse of time between the extinction of the arc and the contact of the end surfaces, the air will not have time to enter, causing both oxidation of the steel and cooling of the surfaces of the billets. During the operation of closing of the gap, care is taken so that the arc is not extinguished, in such a way that the first part of the upsetting operation is carried out in the presence of a high current in order to compensate, by means of a supply of energy by the Joule effect, for cooling due to the diffusion of heat in the billets. The current is interrupted only about a hundred milliseconds after the short-circuit occurs.

The rate at which the steel is consumed when the arc is ignited is a critical parameter and is proportional to the welding power. Said rate should be on average 1.8-2 mm/sec. The starting rate of the welding process is half the average one.

With high-power welding, there is another disadvantage; namely, it happens that the steel burns fast, thus thinning out the “plastic” zone, i.e., the one that is found at a temperature of between 1400° C. and 1500° C. and which is used for upsetting. This can give rise to “cold” shuts. Instead, at powers that are too low, the welding time is lengthened and there may be an insufficient evacuation of the oxides that are formed during scintillation.

The time for ignition of the arc is in general chosen in such a way that a thickness of steel will be melted that is at least equal to the original maximum irregularity of the product and also taking into account the most conservative average speed of fusion, which is approximately 1.8 mm/sec.

The definition of a maximum threshold for the current has the purpose of interrupting the short-circuits rapidly by increasing the distance between the end surfaces to be welded. Said threshold is, however, quite critical to calibrate. In the case of incorrect calibration, the production of short-circuits in the final step of scintillation can jeopardize the goodness of the weld. Even though short-circuits produced at the start of the scintillation step do not jeopardize the weld seriously if they are interrupted within about a hundred milliseconds, they do, however, cause a reduction in the energy supplied to the joints, and this leads to a dispersion of the results.

From what has been said, it emerges that the part of the scintillation step that has the greatest influence on the quality of the welding operation is the final one (the last 2-3 seconds), in which it is absolutely necessary to prevent extinctions of the arc or power drops from occurring.

The third step of the welding process is that of upsetting and follows the scintillation step. In this step, the force of pressure between the billets and the current used are controlled to follow pre-set paths that optimize the quality of the welded joint. At the end of fusion, the current is set at a maximum value, in order to favour the fusion of any areas that may have remained cold and oxidized, which could cause resistance during approach of the two surfaces, and the servo valve that controls positioning of the clamps of the welding machine is opened completely so as to achieve the maximum gap closing speed. The pressure is determined by the expansion vessel PH (high pressure) that supplies the hydraulic circuit. After extinction of the arc occurs, it is important to close the gap as soon as possible to prevent intrusion of air into the welding zone and cooling of the surfaces.

The current goes to zero only when the useful power drops below a given threshold (e.g., 50 kW) or there arises the condition of Time Out (e.g., 200 ms) in the control system.

From an analysis of the product obtained with some known flash-welding machines, there has been detected a high percentage of joints presenting welding defects that managed to reach the rolling stands without being detected by the quality control. These badly welded joints caused problems of quality in the end product and in extreme cases even jamming of the rolling mill.

An in-depth study of the problem, based upon the acquisition of the data on hundreds of welds, has led to the conclusion that the large statistical dispersion of the welding results arises from the large dispersion of certain factors of disturbance that are involved in the welding process. The most important phenomena of disturbance identified are: the irregularities present in the geometry of the surfaces of the joints to be welded, which frequently have areas of the end surfaces of the billets set very far apart from one another which do not mate up, and the different initial temperature of the steel.

It has been found that the control systems according to the state of the art used in the regulation of the welding processes in the machines are unable to deal with major parametric variations of the process when these occur, which leads to the dispersion of the results of the welding process.

Furthermore, amongst the systems for controlling welding for a.c. welding machines, no controller is known that is able to meet the requirements of ruggedness called for to enable operation in certain unfavourable conditions. The majority of known welding controllers (see the following publications: A. P. Chekmarev et al., “Determining the flash allowance for welding hot billets in continuous rolling mills”, Svar. Proiz., 1970, No. 8, p.p. 5-7 and “A new control system for the K-190P rail flash welding machine”; N. V. Podola, V. P. Krivenos, B. L. Grabchev, “Automatic Welding”, Vol. 36, No. 8, August 1983, p.p. 40-43, FIG. 1, Table 3, ref. “AUTOMATIC WELDING”). is based upon a system that causes the clamps to follow a parabolic path of open-loop position, i.e., irrespective of the measurements of voltage and arc current. Said path is modified only in the case of occurrence of short-circuits, in which case there is added, to the parabolic path of pre-defined position, a small step of opening-up of the clamps.

In this way, the system of movement is unable to stabilize the geometry of the arc in so far as it does not take said geometry into consideration.

The patent U.S. Pat. No. 4,940,876 describes an arc-impedance controller for a.c. welding machines. The regulator maintains the arc impedance constant by acting on the hydraulic position control. The short-circuit impedance, which is an essential parameter in the system of calculation adopted, is measured and re-updated, in the upsetting step, at the end of each welding cycle. In this way, this control system does not, however, take into account in any way the fact that the characteristic of the arc in the initial moments of the welding process varies enormously and hence does not remain constant in the course of a welding cycle. This variation occurs because, especially in the presence of irregular end surfaces, the electric arc starts first in one point of the joints where these are set closer to one another and is then widened progressively to the rest of the end surface, employing, however, a few seconds to involve the entire joint. In order to maintain the arc impedance constant in this step in the presence of an arc that changes characteristic, the said control system is unable to prevent short-circuits from being formed during ignition. Since at each short-circuit there is an extinction of the arc and hence a reduction in the thermal energy supplied to the joints, this type of controller produces irregularities in the energy supplied to the weld, and hence there is a dispersion of the results.

### SUMMARY OF THE INVENTION

The main purpose of the present invention is to eliminate the disadvantages cited, according to a first aspect of the invention, by means of a method for controlling a butt-welding machine of the “flash-welding” type according to Claim 1 and, according to a second aspect of the invention, by means of a control system with the characteristics of Claim 3.

A diagnostics system according to the present invention, by acting simultaneously on the variable parameters that intervene in the various steps of the welding operation, is able to optimize the results of said operation.

In particular, the present invention overcomes problems left unresolved by known controllers and, in particular, by the impedance controller described in U.S. Pat. No. 4,940,876 mentioned previously, which, amongst controllers, constitutes one of the more advanced embodiments but which does not act on the supply voltage to improve the welding control.

In order to obtain optimal results, the control system according to the invention controls, during the scintillation step, not only arc impedance but also a plurality of other variables, amongst which, in the first place, the arc length. Thanks to this fact, there is drastically reduced the possibility of short-circuits occurring in so far as the control of length of the arc in effect prevents the joints from touching one another. This is done by estimating the arc length with a mathematical model that is based upon the knowledge of the physical laws that determine the behaviour of the process, and on direct measurements. Furthermore, to guarantee the supply of the power desired also on an variable arc impedance, the primary voltage is controlled by acting on the angle of triggering of the partializer. If upon starting of the arc at the start of the scintillation step the arc is confined in a small part of the facing surfaces that are to be welded on account of irregularities of said surfaces, said arc thus presents, given the same length, a high impedance. The control system increases the supply voltage so as to supply in any case full power to the arc that melts more rapidly the surface irregularities, on which the arc has started. This hence favours a rapid elimination of the irregularities by evening out the end surfaces to be welded.

Then, the thermal power supplied is reduced progressively in the last second of the scintillation step to give rise to a more extensive ‘plastic’ layer in the area of the billets in the vicinity of the end surfaces, which improves the quality of the weld.

In order to overcome also the problem of extreme variations in the conditions for which the control system does not have margins of time that can be used and of power that can be supplied, sufficient for bringing the welding operation to an end properly, there is advantageously provided a system of on-line diagnosis that recognizes the welded joint in a reliable way and enables elimination thereof from the processing line.

A further advantage of the control system according to the invention is the presence of a dynamic state observer that, considering the entire history of the welding process up to the present moment, is able to reconstruct and also to forecast for the subsequent instants the trend of a large number of state and performance variables, on which the action of control and diagnosis is based. The simultaneous control of these variables, for the purpose of keeping them on pre-defined paths, leads to an improvement in performance as compared to known control systems, which are based only on the detection of some variables that are directly measurable, a fact which renders the welding process less reliable.

The combination of all these elements, envisaged in the control system according to the invention, determines the superior weld quality in the billets.

Amongst the main purposes that the control system makes possible, there is that of rendering more reliable and repetitive, in each step of the welding operation, the trend of the electrical, thermal and mechanical state variables of the welding system, as well as that of possibly not allowing any joints in which the welding operation has not been altogether successful to move on for the subsequent processing steps.

### LIST OF FIGURES

Further advantages that may be achieved with the present invention will emerge more clearly to a person skilled in the art from the ensuing detailed description of a particular and non-limiting embodiment of a system for on-line control of a butt-welding machine with reference to the following figures, in which:

FIG. 1 is the block diagram of the control system according to the invention;

FIG. 2 is the functional logic diagram of the method according to the invention; and

FIG. 3 presents a number of graphs with optimal paths of some performance variables.

### DETAILED DESCRIPTION OF THE INVENTION

The solution according to the invention for solving the technical problem provides for a method for control and on-line diagnosis of a butt-welding machine of the “flash-welding” type, adapted to be included in a continuous process for the fabrication of blooms and billets.

The method according to the invention substantially envisages controlling, on the basis of pre-determined criteria illustrated in greater detail in the ensuing description, two actuators that act respectively on the angle of triggering of the partializer for controlling the electric machine that supplies the thermal power to the weld and on the opening of the valve that controls positioning of the clamps of the welding machine.

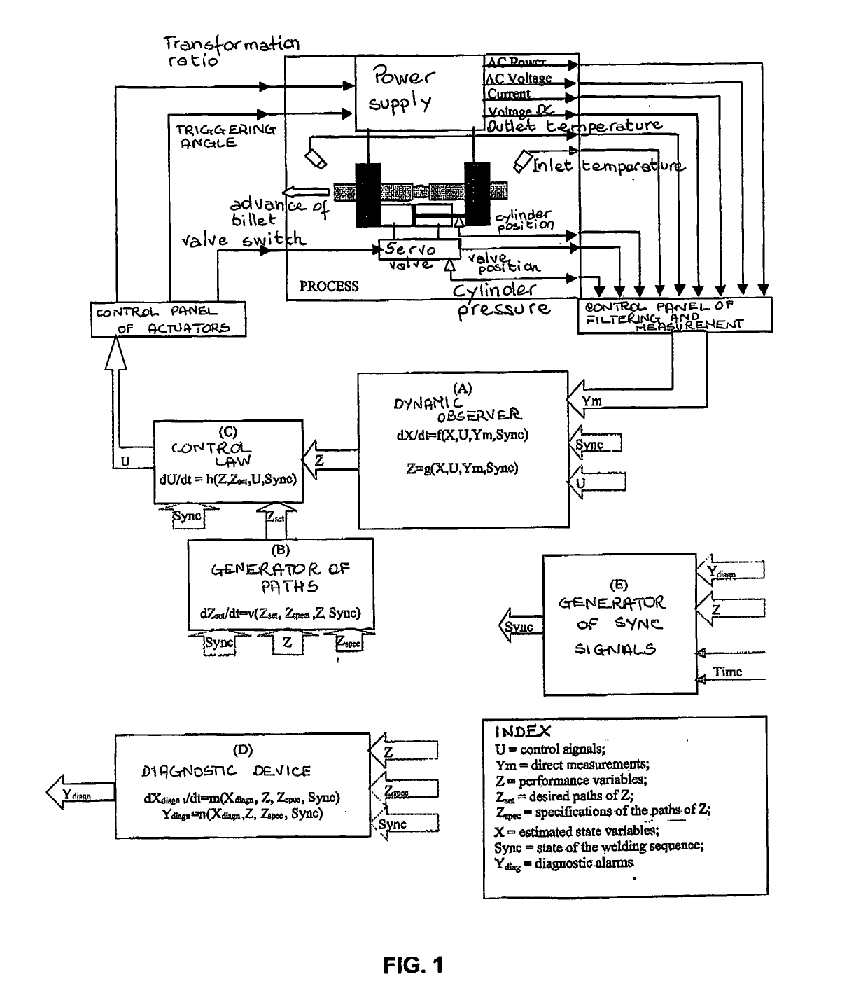

With particular reference to FIG. 1, in which the following symbols are used:
U=control signals;
Ym=direct measurements;
Z=performance variables;
Zₛₑₜ=desired paths of Z;
Z_{spec}=specifications of the paths of Z;
X=estimated state variables;
Sync=state of the welding sequence; and
Y_{diag}=diagnostic alarms,
   the method according to the invention is implemented via a control system comprising a multivariable dynamic control law, block C, based upon techniques of multi-objective optimization and of robust synthesis capable of maintaining under accurate control all the paths of the variables that determine the quality of the process, even in conditions where there is uncertainty on the parameters that define the characteristic of the arc and the geometry of the joints, so as to cause the trends of all the electrical, mechanical and thermal quantities to converge rapidly, right from the start of the welding operation, towards the desired values, notwithstanding the occurrence of wide parametric variations in the course of the welding process.

According to a particularly advantageous aspect of the invention, the control system also envisages a diagnostics system capable of identifying the joints that it had not been possible to weld correctly on account of the presence of extreme values of the disturbance phenomena.

The dynamic control law, block C, acts simultaneously on the angle of triggering of a partializer, which regulates the supply, and on the hydraulic control of movement of the clamps by maintaining the real trend of the electrical, mechanical and thermal values of the welding process close to the optimal trend. Since not all the variables that determine the trend of the welding process can be measured, there is provided a method of estimation based upon a mathematical and heuristic model that reconstructs on line the variables necessary for completing the information on the state of the weld. On the basis of these state variables, the variables that determine the quality of the process are identified, the trend of which determines the goodness of the global result of the weld. For these variables, which we shall call “performance variables”, through tests, the optimal paths that should be followed during the welding operation have been determined. On the basis of the performance variables supplied by a dynamic state observer there has been developed also a diagnostics system capable of detecting whether the weld has failed to reach the desired quality on account of the occurrence of some problem. The alarm generated by this diagnostics system enables the defective joint to be prevented from proceeding to the subsequent processing step.

The control system according to the invention comprises the functional blocks described in what follows with particular reference to FIG. 1.

The system comprises a dynamic state observer, block A, which detects the state of the welding process X, detecting also those components that are not measured directly but the trend of which has important effects on the final result. The dynamic observer, block A, uses the direct measurements Ym, the input controls U, and a set of physical laws and of experimental rules that define the trend of the process (f(X, U, Ym, Sync)) to obtain an image of the state in which the welding process is found and to forecast its evolution dX/dt in time. The dynamic state observer, block A, supplies a plurality of outputs of performance Z that represent those variables the paths of which define a good result of the welding operation. Also included in this plurality of performance variables Z are quantities which, since they are not measurable directly, are obtained by interpreting the dynamic evolution of the process through physical and experimental laws appropriately stored in the dynamic observer A. Thanks to said plurality of performance variables Z, the activity of control and on-line diagnostics of the control system is performed. The variables that in the various steps have the function of identifying the state and the results of the welding process are reconstructed by the dynamic state observer A.

Amongst the performance variables considered are advantageously: pressure in the cylinder; position of the cylinder; speed of the cylinder; position of the servo valve; angle of triggering of the partializer; transformation ratio of the transformer, used only in the case where the controller is able to control it automatically; electric power absorbed by the network; voltage of the d.c. supply to the terminals of the transformer; arc voltage; arc current; thermal energy supplied to the joints; thermal power communicated to the joints; thermal map of the joints; width of the gap between the joints; quantity of molten metal; rate of fusion of the joints; arc power; electric power supplied by the power supply; and arc impedance.

The dynamic state observer, block A, envisages the trend of the process in response to the control inputs with the use of algorithms that take into account physical and experimental laws, and uses the measurements only for updating the forecasts made and for correcting the value of those parameters that are subject to time variations.

Amongst the parameters that can vary in time and that the dynamic state observer, block A, identifies on line in the course of the execution of the welding process there are: the parameters corresponding to the voltage-current-arc length characteristic, the thermal efficiency of the arc, defined as ratio between thermal energy supplied to the joints and electrical energy supplied to the arc, the efficiency of the power supply, the resistance of the d.c. circuit, and the position of the joints at the start of welding operation. In the case of a failure to some system of direct measurement of a variable, the dynamic state observer A continues in any case to forecast the trend of said variable, and, even though the latter is no longer measured, the dynamic control law, block C, is able to regulate the process even so, albeit with slightly degraded performance.

Another element comprised in the control system is the dynamic generator of paths for the performance variables, block B, which uses algorithms based upon physical laws and experimental rules, of the type g(X, U, Ym, Sync). The dynamic generator of paths supplies the optimal paths Zₛₑₜ that it is desired to get the performance variables Z to follow. The paths are configured via a set of parameters Z_{spec} appropriately chosen by the designer.

In the control system there is provided the already cited dynamic control law, block C, which calculates the control for the actuators U on the basis of the values of the performance variables Z and of the optimal paths Zₛₑₜ.

There is moreover provided a dynamic diagnostic device, block D, which, by comparing the paths of the performance variables with the desired ones, generates indices of weld quality X_{diag}. If these indices of quality fall outside a pre-determined interval, an alarm signal is generated that causes adoption by the dynamic control law, block C, of a strategy of recovery of the weld, which envisages the interruption of the welding operation prior to the upsetting step. In extreme cases, in which the alarm has been generated during the upsetting step, the next step will be cutting of the welded joint. The dynamic diagnostic device D also controls the efficiency of the measuring and actuating device. In the case of a failure, alarms are generated, which induce the dynamic control law, block C, to adopt a control strategy suitable for operating in degraded conditions.

The system also comprises a generator of sync signals, represented by block E, (also called Sequence Manager) that induces the dynamic control law, block C, to adopt, in each step of the welding operation, the appropriate operating strategy, sending the appropriate signals to all the blocks of the control system.

The operating modality of the dynamic state observer, block A, according to the invention is performed in the following way. Throughout the welding process, the state observer, block A, follows the profile of the joint to be welded. By detecting the behaviour of the actuators U, which comprise an electric power supply and a hydraulic valve, the dynamic state observer A calculates the state of voltages and currents of the circuit, calculates the balance of thermal power in the joints, detects the thermal map of the billet, the geometry of the electric arc, and the state of the system of hydraulic movement. By comparing the estimated values of the variables with the respective effective measurements, the state observer A updates the estimated state and the value of the parameters that are subject to variation by carrying out their identification on line.

The strategy of observation changes in the different steps of the welding process according to the operating modalities defined by the generator of sync signals, block E. From the reconstructed state of the process, the state observer generates performance variables Z that represent the main paths to be controlled for a good weld result, the variables on which to carry out the diagnostic inference, the variables that enable the sync generator to establish the passages from one step to another of the welding process and the changes of operating mode.

The operating mode of the generator of optimal paths, block B, is described in what follows. The optimal paths Zₛₑₜ are variable in time and are calculated starting from certain set-up parameters Z_{spec} of the machine.

The performance variables Z to which paths are assigned for control of the pre-heating step comprise the force of compression of the billets to be welded, the speed of displacement of the joints, the current to be made to flow in the joints, and the time of contact between the joints.

The performance variables Z to which paths are assigned for control of the scintillation step comprise the length of the arc, the thermal power supplied by the arc, the arc voltage, the arc impedance, and the temperature profile on the joints.

The performance variables Z to which paths are assigned for control of the upsetting step comprise the pressure of upsetting of the billets, the current to be made to flow in the joints, and the position of the joints.

The optimal paths for the performance variables Z that are a dynamic function of the time and of the performance variables Z themselves and are generated, using appropriate algorithms, which incorporate a set of rules obtained from physical laws and from experimental data.

Since the performance variables are mutually dependent, being linked by precise relations, e.g., arc impedance, arc voltage, arc current, there suffice a few set-up parameters Z_{spec} in order to define the trends of innumerable paths for the performance variables Z.

The operating modality of the dynamic control law, block C, is described in what follows. The dynamic control law, block C, induces a subset of the performance variables Z, selected according to the step of the process, to follow the respective optimal paths. If it is not possible to follow exactly all the paths specified, the dynamic control law, block C, minimizes a weighted average of the tracking errors of the paths; the weights of this average are determined by the control gains and calculated with a technique of multi-objective optimization. In this way the biggest errors will be the ones that will yield the greatest contribution to the action of control.

The operating modality of the dynamic diagnostic device, block D, is performed as follows. The primary purpose of the diagnostic device is that of interrupting the welding operation in the event of some unforeseeable factor of disturbance detected by the dynamic diagnostic device were to degrade the quality of the weld. A poor weld can be extremely dangerous since it can cause jamming in the subsequent processing steps, in particular in the rolling mill.

The most frequent and most critical factor of disturbance consists in a marked irregularity in the profile of the joints to be welded; however, there may occur also other disturbance such as high resistances of contact with the clamps that do not enable communication of the desired power to the arc, variations in line voltage, etc.

A further function performed by the dynamic diagnostic device D is that of detecting possible failures in the welding system.

The dynamic diagnostic device, block D, is supplied by the performance variables Z and by the path specifications Zₛₑₜ. Starting from these input variables, it generates dynamically within it a number of diagnostic variables Ydiagn by means of an algorithm based upon a set of physical rules and experimental intervals of values X_{diagn}. If the diagnostic variables Ydiagn exit from the respective intervals of values pre-set experimentally, the diagnostic device D issues specific alarms. The alarms are sent to the generator of sync signals, block E, which implements accordingly the adequate response strategy.

The operating modality of the sync-signal generator, block E, is described in what follows. The sync-signal generator has the principal task of informing the functional block of the control system on the state of the welding sequence. The welding sequence fundamentally comprises the three steps mentioned: pre-heating, scintillation, and upsetting. Each of these is further split into substeps. The start of the welding cycle is determined by an enabling signal, which is issued by the central control system of the rolling mill, which can be integrated in the system for controlling welding, if necessary, in the instant in which the billet to be welded has been correctly positioned on the welding machine.

Transition from one step to another of the welding cycle is determined on the basis of the time or on the basis of certain conditions of the performance variables Z being reached.

The sync-signal generator, block E, informs the blocks of the control system as regards the step and the substep of the welding cycle in which it is operating.

The operating modality of each step of the control process can be modified in the event where alarms have been issued by the diagnostic device, block D. The sync generator receives said diagnostic alarms, interprets them, and sends, to the blocks of the control system, the commands to proceed in the correct mode of degraded operation.

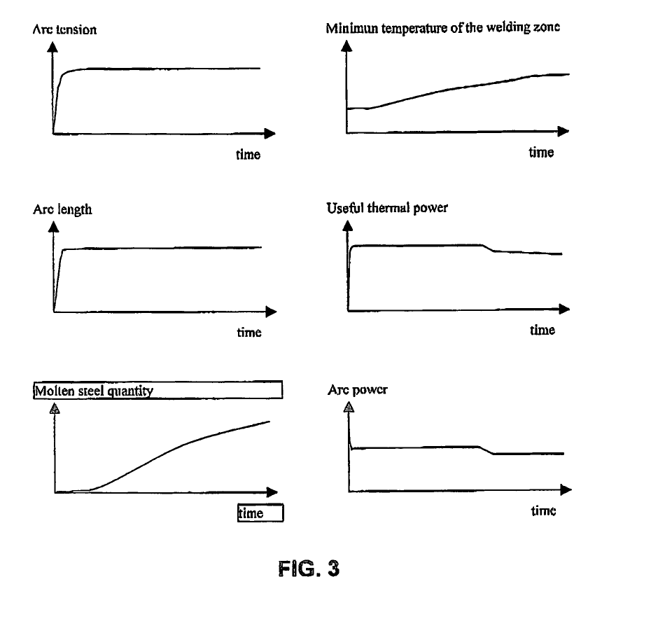

A number of optimal paths set during scintillation on some performance variables not directly measured are illustrated, by way of advantageous example, in the graphs of FIG. 3.

The system for controlling a butt-welding machine according to the invention described above can be obtained by means of a purposely designed computerized system, or also, in a particularly advantageous way, by means of a program for a general-purpose electronic processor, e.g., a PC. In this case, the functional blocks described above, i.e., the dynamic state observer A, the dynamic path generator B, the dynamic control law C, the generator of sync signals E, and the dynamic diagnostics system D correspond to the software blocks, appropriately written in the programming language suited to optimal use on the type of processor used for control of the welding machine.

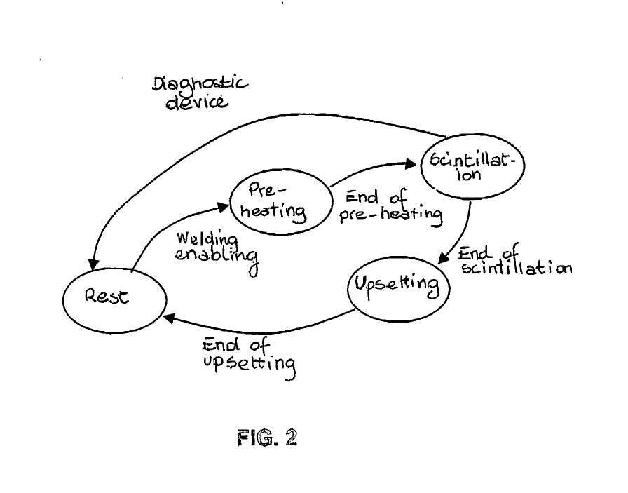

The diagram indicated in FIG. 2 represents the flow, or logic functional diagram, of the process with the indication of the quantities that enable the passage from one stage of the welding process to the next. There emerges clearly the advantage that the presence of the diagnostics system according to the invention affords with respect to known control systems, whereby via on-line check, during the flashing step, the quality of the joint can discriminate the subsequent state. In this way, the defective welds can be rejected without this creating problems during the subsequent processing operations.

1. A method for on-line control of a butt-welding machine of the flash-welding type for bars, blooms or billets, during welding cycles, comprising the steps of
controlling an actuation of a valve controlling positioning of clamps of the welding machine; and
controlling the triggering angle of a partializer for controlling the thermal power supplied to the welding process;
said controlling steps being regulated on the basis of an analysis by a dynamic state observer (A) of the history of the welding process during execution of each welding cycle, characterised by the fact that said dynamic state observer (A) estimates, by means of a mathematical model, the trend of a plurality of state variables (X) and of performance variables (Z), the latter comprising at least the arc length, used as basis for controlling the welding cycle itself and the subsequent welding cycles, using a plurality of direct measurements (Ym).

2. The method according to claim 1, wherein for regulating said controlling steps there is provided:
observing state variables (X) of the welding cycles by the dynamic state observer (A);
defining pre-determined optimal paths (Zₛₑₜ) to be followed by a plurality of performance variables (Z) by means of a dynamic path generator (B) for performance variables (Z);
executing a dynamic control law (C) based upon the value of the performance variables (Z), of the optimal paths (Zₛₑₜ) and of an operating strategy determined according to the step that the welding process is undergoing; and
generating sync signals (Sync) by means of a signal generator (E), on the basis of which the dynamic control law (C) adopts the given operating strategies.

3. The method according to claim 2, wherein the dynamic control law (C), during a scintillation step of the welding process, maintains the arc length constant and varies the primary voltage on the basis of the variation of arc impedance.

4. The method according to claim 3, wherein an on-line diagnosis is provided by a dynamic diagnostics system (D), for which the comparison of the paths of the performance variables (Z) is made with the desired paths (Zₛₑₜ) by said dynamic diagnostics system (D), generating weld quality indices.

5. The method according to claim 6, wherein there is provided automatic on-line variation of the transformation ratio of a transformer (tap changing) for supply of the butt-welding machine.

6. A system for controlling a butt-welding machine for bars, blooms or billets, wherein the machine comprises a valve for controlling positioning of clamps of the machine, and a partializer, wherein the control system is adapted to perform the method according to claim 1 and comprises:
a dynamic state observer (A) adapted for observing a plurality of state variables (X) of a welding process carried out by said machine;
a dynamic path generator (B) for performance variables (Z), adapted for defining pre-determined optimal paths (Zₛₑₜ) for the performance variables (Z) to follow, the latter comprising at least an arc length;
a dynamic control law (C) adapted for controlling the valve and the partializer on the basis of the value of the performance variables (Z) and of the optimal pre-determined paths (Zₛₑₜ); and
a generator (E) of sync signals adapted for generating sync signals (Sync).

7. The system according to claim 6, wherein there is provided a transformation ratio variator (tap changer), adapted for controlling the transformation ratio.

8. The system according to claim 7, wherein a dynamic diagnostics system (D) is provided, adapted for generating indices of weld quality, comparing the paths of the performance variables (Z) with the desired paths (Zₛₑₜ).

9. The system according to claim 8, wherein the observer (A) of dynamic state, the dynamic path generator (B), the dynamic control law (C), the generator of sync signals (E), and the dynamic diagnostics system (D) are implemented by means of a computer program.

10. (canceled)

11. (canceled)
